(19) United States
(12) Patent Application Publication
(10) Pub. No.: US 2026/0243439 A1
(43) Pub. Date: Aug. 20, 2026

(54) ADJUSTABLE OVEN RACK ASSEMBLY FOR OVEN APPLIANCE

(71) Applicant: Haier US Appliance Solutions, Inc., Wilmington, DE (US)

(72) Inventors: Brett Alan Farris, Louisville, KY (US); Steven Keith Root, Buckner, KY (US)

(21) Appl. No.: 19/058,083

(22) Filed: Feb. 20, 2025

(51) Int. Cl. F24C 15/16; A47J 36/32; A47J 36/34; G05D 3/20; G06T 7/60; G06T 7/70

(52) U.S. Cl. CPC F24C 15/16; A47J 36/32; A47J 36/34; G05D 3/20; G06T 7/60; G06T 7/70

(57) ABSTRACT

Oven appliance and associated methods for operating an oven appliance including an adjustable rack assembly. The oven appliance includes a cabinet defining a cooking chamber and a cabinet door. An adjustable rack assembly is positioned within the cabinet and includes a rack frame, vertical positioning assembly, a camera assembly, and a controller. The adjustable rack assembly is configured to move the rack frame in the vertical direction using data from camera assembly based on user preference or manufacturer default setting.

### FIELD OF THE INVENTION

The present disclosure relates generally to oven appliances, and more particularly to adjustable oven rack assemblies for oven appliances.

### BACKGROUND OF THE INVENTION

Conventional residential and commercial ovens generally include a cabinet that includes a cooking chamber for receipt of food items for cooking. Multiple gas or electric heating elements are positioned within the cabinet for heating the cooking chamber to cook food items located therein. The heating elements can include, for example, a bake heating assembly positioned at a bottom of the cooking chamber and a separate broiler heating assembly positioned at a top of the cooking chamber.

Typically, food or utensils for cooking are placed on wire racks within the cooking chamber and above the bake heating assembly. In some instances, protective or radiant plates are positioned over the bake heating assembly to protect the bake heating assembly or assist in evenly distributing heat across the bottom of the cooking chamber. Oftentimes, wire racks are at least mounted well above a bake heating assembly to ensure the bake heating assembly is not damaged or a user does not accidentally contact the bake heating assembly. The choices for the height of the wire racks are limited to a finite number of guide channels in the cooking chamber. These guide channels are set at pre-determined static heights based on design choices. Additionally, these wire racks may be a flat rack or a roller rack but require the user to manually move the oven rack to extend out of the cooking chamber for easier loading or unloading.

Although these conventional configurations are useful to many individuals for many types of foods, there are certain disadvantages. For instance, in many cases a vessel or container is required to hold one or more food items within a cooking chamber on a wire rack. Even with such vessels, some foods or liquids may extend vertically from the vessel and may come in contact with the top of the cooking chamber or leave negligible room to place or remove the vessel from the cooking chamber. This may result in the user manually changing the wire rack location to a lower available guard channel. Additionally or alternatively, placing a vessel, container, or a food item in a lower wire rack raises ergonomic concerns for the user loading and/or unloading the vessel or container. If the user prioritizes the ergonomic placement of a vessel or container or food, then the wire rack location may not be ideally positioned. Also, having the user manually extend the wire rack creates a risk of burns through physical contact with the wire rack in addition to potential ergonomic concerns due to the static nature of the wire rack on the vertical axis of the cooking chamber.

Accordingly, improved oven rack assemblies for oven appliances and associated methods for loading items on and unloading items from the oven racks would be useful. More specifically, an adjustable oven rack assembly and associated methods that can account for the user's preferences, the user's ergonomic needs, and spacing requirements would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment, an oven appliance defining a mutually orthogonal vertical direction, lateral direction, and transverse direction is provided. The oven appliance includes a cabinet defining a cooking chamber, a cabinet door, and an adjustable rack assembly. The adjustable rack assembly includes a rack frame extending along a transverse direction between a front end a rear end, a vertical positioning assembly supporting the rack frame within the cabinet, a camera assembly for obtaining images of the cooking chamber, and a controller in operative communication with the vertical positioning assembly and the camera assembly. The controller is configured to obtain an image of the cooking chamber using the camera assembly, and operate the vertical positioning assembly to position the rack frame based at least in part on the image of the cooking chamber.

In another exemplary embodiment, an adjustable rack assembly for an oven appliance is provided. The adjustable rack assembly includes rack frame extending along a transverse direction between a front end a rear end, a vertical positioning assembly supporting the rack frame within a cabinet defining a cooking chamber, a camera assembly for obtaining images of the cooking chamber, and a controller in operative communication with the vertical positioning assembly and the camera assembly. The controller is configured to obtain an image of the cooking chamber using the camera assembly, and operate the vertical positioning assembly to position the rack frame based at least in part on the image of the cooking chamber.

In accordance with another embodiment, a method for operating an oven appliance is provided. The oven appliance includes a cabinet defining a cooking chamber; a cabinet door; and an adjustable rack assembly, the adjustable rack assembly includes a rack frame extending along a transverse direction between a front end and a rear end, a vertical positioning assembly supporting the rack frame within the cabinet, and a controller in operative communication with the vertical positioning assembly and a camera assembly, the controller being configured to obtain an image of the cooking chamber using the camera assembly, and operate the vertical positioning assembly to position the rack frame based at least in part on the image of the cooking chamber. The method for operating an oven appliance includes determining a position of the cabinet door, obtaining a target rack frame position defining an intended position of the rack frame, obtaining data from a camera to determine a height of an item defined by a container, vessel, and/or food item located on the rack frame, evaluating whether the height of the item will come into contact with a top of the cooking chamber when the rack frame would be positioned at the target rack frame position and updating the intended position of the rack frame accordingly, activating the vertical positioning assembly when the cabinet door is closed, and moving the rack frame via the vertical positioning assembly to the target rack frame position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a cloud system for an oven appliance and a front view of an oven appliance, in accordance with one example embodiment of the present disclosure.

FIG. 2 provides a perspective, cross-sectional view of the example oven appliance of FIG. 1, taken along Line 2-2 in FIG. 1 according to an example embodiment of the present subject matter.

FIG. 3 is a side, cross-sectional view of the example oven appliance of FIG. 1, taken along Line 2-2 in FIG. 1 according to an example embodiment of the present subject matter.

FIG. 4 is a rear view of a camera assembly that may be used within a cabinet door of the example oven appliance of FIG. 1 according to an example embodiment of the present subject matter.

FIG. 5 is a front view of a camera assembly that may be used within a cabinet door of the example oven appliance of FIG. 1 according to an example embodiment of the present subject matter.

FIG. 6 is a side schematic view of an adjustable rack assembly that may be used within the example oven appliance of FIG. 1 according to an example embodiment of the present subject matter.

FIG. 7 illustrates a method for operating an oven appliance in accordance with one embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and may not be intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. As used herein, the terms “coupled,” “fixed,” “attached to,” and the like refer to both direct coupling, fixing, or attaching, as well as indirect coupling, fixing, or attaching through one or more intermediate components or features, unless otherwise specified herein. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to systems and associated methods for operating an oven appliance including an adjustable rack assembly. An oven appliance may include a cabinet defining a cooking chamber including an adjustable rack assembly capable of movement in the vertical direction and the lateral direction. The oven appliance may also include a controller in operative communication with a camera assembly configured to obtain an image of the cooking chamber using the camera assembly and move the adjustable rack assembly based at least in part on the image of the cooking chamber. Thus, this approach to the operation of an oven appliance materially minimizes risk of a food item defined by a container, vessel, and/or food item located on the adjustable rack assembly contacting the top of the cooking chamber, while providing the user with potential ergonomic benefits by specifying the location of the adjustable rack assembly.

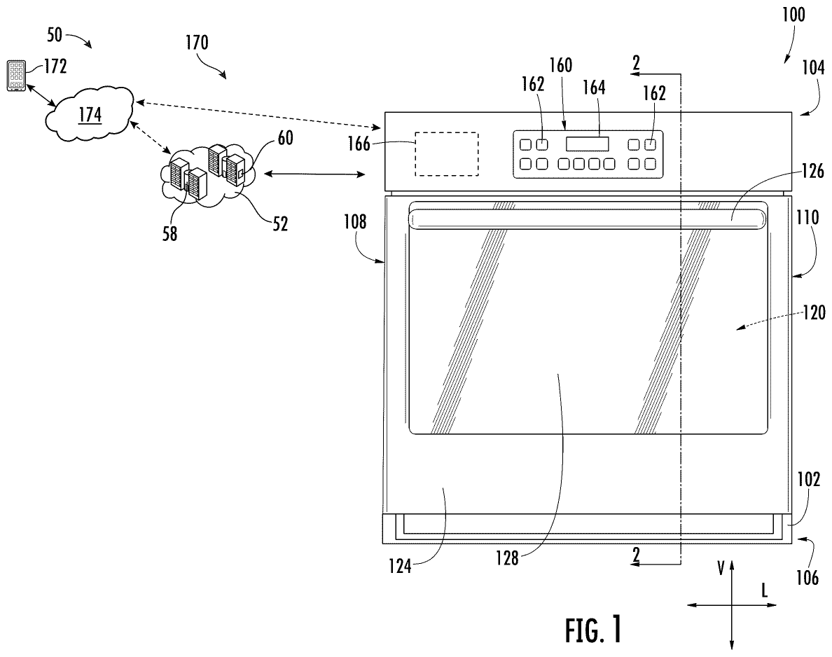

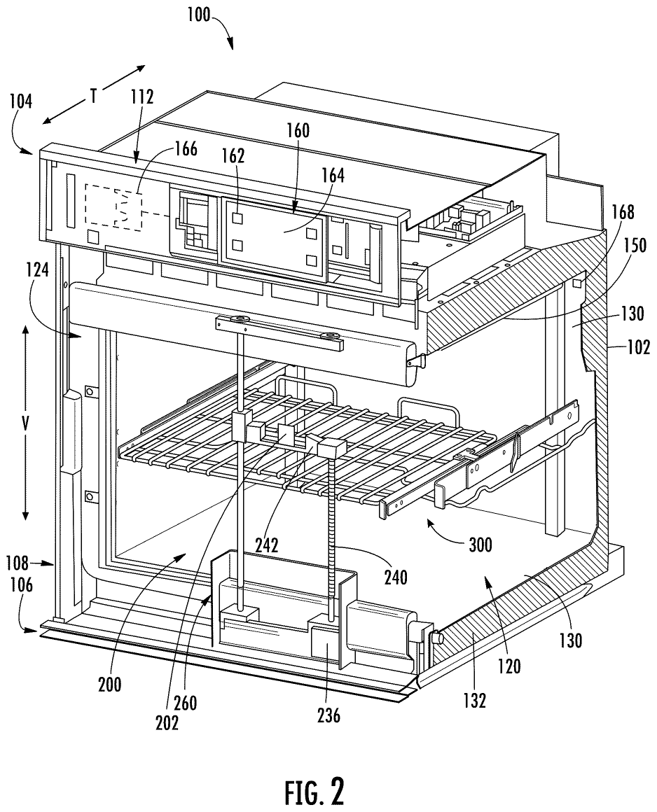

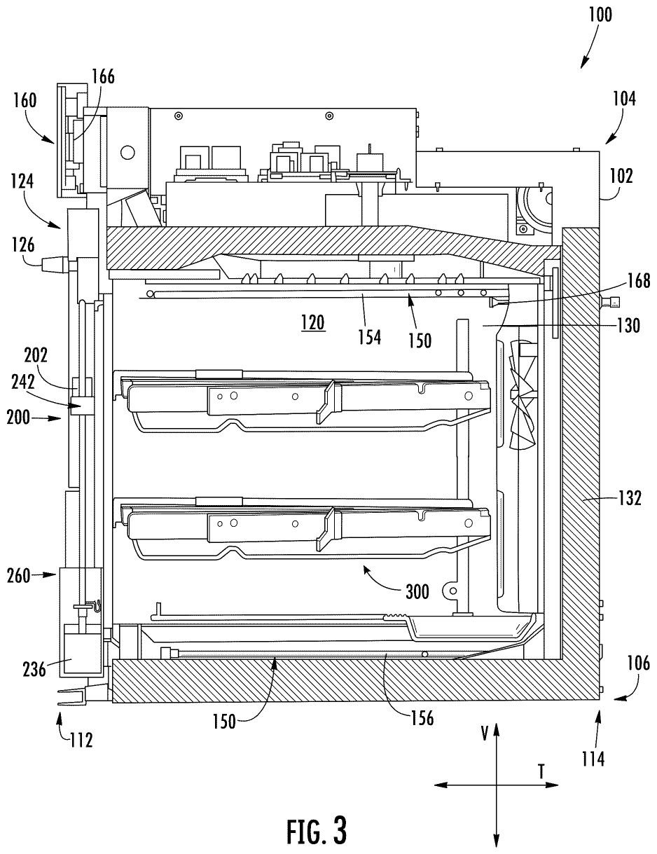

In FIG. 1, a front view of an oven appliance 100 as well as a schematic view of a cloud system 50 are provided as may be employed with present subject matter. In addition, FIGS. 2 and 3 provide perspective and side cross-sectional views, respectively, of oven appliance 100. Referring generally to FIGS. 1 through 3, oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front end 112 and a rear end 114 along the transverse direction T. The first side 108 and/or second side 110 may be herein referred to as “cabinet wall.”

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a gas or electric double oven range appliance. For example, although oven appliance 100 is illustrated as a wall oven installed within a bank of cabinets, it should be appreciated that aspects of the present subject matter may be used in free-standing oven appliances, double ovens, etc. Moreover, aspects of the present subject matter may be used in any other consumer or commercial appliance where it is desirable to use a camera and/or an adjustable assembly rack within another suitable appliance. Thus, the example embodiment shown in FIGS. 1 through 3 is not intended to limit the present subject matter to any particular cooking chamber configuration or arrangement.

Oven appliance 100 includes a cabinet door 124 rotatably attached to cabinet 102 in order to permit selective access to cooking chamber 120. Handle 126 is mounted to cabinet door 124 to assist a user with opening and closing cabinet door 124 in order to access cooking chamber 120. As an example, a user can pull on handle 126 mounted to cabinet door 124 to open or close cabinet door 124 and access cooking chamber 120. One or more transparent viewing windows 128 (FIG. 1) may be defined within cabinet door 124 to provide for viewing the contents of cooking chamber 120 when cabinet door 124 is closed and also assist with insulating cooking chamber 120. In one example embodiment, oven appliance 100 may include a means of determining the position of cabinet door 124. The means of determining the position of the cabinet door 124 may include but is not limited to a sensor, switch, motion detector, etc. In another example embodiment, a first viewing window 128 may be mounted within the first end of a housing 242, and a second viewing window 128 may be mounted within the second end of the housing 242. According to alternative embodiments, windows 128 may be omitted from cabinet door 124 altogether, while cavity visibility may be maintained using a camera system, e.g., as described herein.

In general, cooking chamber 120 is defined by a plurality of chamber walls 130 (FIGS. 2 and 3). Specifically, cooking chamber 120 may be defined by a top wall, a rear wall, a bottom wall, and two sidewalls 130. These chamber walls 130 may be joined together to define an opening through which a user may selectively access cooking chamber 120 by opening cabinet door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Oven appliance may further include one or more heating elements (identified generally by reference numeral 150) positioned within cabinet 102 or may otherwise be in thermal communication with cooking chamber 120 for regulating the temperature within cooking chamber 120. For example, heating elements 150 may be electric resistance heating elements, gas burners, microwave heating elements, halogen heating elements, or suitable combinations thereof. According to an exemplary embodiment, oven appliance 100 is a self-cleaning oven. In this regard, heating elements 150 may be configured for heating cooking chamber 120 to a very high temperature (e.g., 800° F. or higher) in order to burn off any food residue or otherwise clean cooking chamber 120.

Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on the, e.g., the size of oven appliance 100 or the desired heat output. Oven appliance 100 may include any other suitable number, type, and configuration of heating elements 150 within cabinet 102. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes user inputs 162 that may generally be configured for regulating heating elements 150 or operation of oven appliance 100. Additionally, user interface panel 160 may be configured to communicate via a controller 166 to an exemplary cloud system 50 to interact with at least one consumer device. Although cloud system 50 is illustrated herein as interacting with a single appliance (i.e., oven appliance 100), it should be appreciated that this schematic representation is only intended to facilitate discussion of aspects of the present subject matter. In this regard, for example, cloud system 50 and the methods described herein may be used to simultaneously monitor a plurality of appliances located in the same household or in different locations and/or having different owners. In this regard, for example, although the exemplary appliance is shown as an oven appliance in FIG. 1, it is recognized that the benefits of the present disclosure apply to other types and styles of appliances. For instance, the present disclosure is understood to apply to refrigerator appliances, dishwasher appliances, washing machine appliances, dryer appliances, microwave appliances, air conditioning appliances, etc. Consequently, the description set forth herein is for illustrative purposes only and is not intended to be limiting in any aspect to any particular appliance or configuration.

Cloud system 50 may include a cloud server 52 that is connected to oven appliance 100 or any other suitable appliance or appliances for performing analysis, data processing, or otherwise improving the performance of one or more appliances. Furthermore, cloud server 52 may include or may be in operative communication with a guidance service (e.g., identified herein generally by reference numeral 58) for communicating appliance data and/or historical data for similar appliances. Although cloud server 52 and guidance service 58 are illustrated in FIG. 1 as being stored on separate servers that are in communication with each other, it should be appreciated that according to alternative embodiments other system configurations are possible. For example, cloud server 52 and guidance service 58 may be embodied in or incorporated into a single remote server or even a single model on a server.

As illustrated in FIG. 1, a schematic diagram of an external communication system 170 will be described according to an exemplary embodiment of the present subject matter. In general, external communication system 170 is configured for permitting interaction, data transfer, and other communications between oven appliance 100 and one or more external devices (e.g., such as portions of cloud system 50). For example, this communication may be used to provide and receive operating parameters, user instructions or notifications, performance characteristics, user preferences (e.g., such as user inputs 162), fault conditions or data, or any other suitable information for improved performance of oven appliance 100. In addition, it should be appreciated that external communication system 170 may be used to transfer data or other information to improve performance of one or more external devices or appliances and/or improve user interaction with such devices.

For example, external communication system 170 permits controller 166 of oven appliance 100 to communicate with a separate device external to oven appliance 100, referred to generally herein as cloud server 52. In addition, external communication system 170 may permit controller 166 of oven appliance 100 to communicate with a remote device 172, such as a personal phone, a smartphone, a tablet, a laptop or personal computer, a wearable device, a smart home system, or another mobile or remote device. These communications may be facilitated using a wired or wireless connection, such as via a network 174. In general, cloud server 52 may be any suitable device separate from oven appliance 100 that is configured to provide and/or receive communications, information, data, or commands from a user. In this regard, cloud server 52 may be, for example, a cloud-based server located at a distant location, such as in a separate state, country, etc. According to an exemplary embodiment, oven appliance 100 may communicate with cloud server 52 over network 174, such as the Internet, to transmit/receive data or information, provide user inputs, receive user notifications or instructions, interact with or control oven appliance 100, etc. According to exemplary embodiments, cloud server 52 may be configured to receive appliance data and diagnose or predict potential fault conditions, e.g., determining whether the height of a food item or vessel will come into contact with a top of the cooking chamber when an adjustable rack assembly 300 would be positioned at a target rack frame position based on user preference or manufacturer defaults.

In general, communication between oven appliance 100, cloud server 52, and/or other user devices or appliances may be carried using any type of wired or wireless connection and using any suitable type of communication network, non-limiting examples of which are provided below. For example, cloud server 52 may be in direct or indirect communication with oven appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

In some embodiments, cloud server 52 can store or include one or more machine-learned models (e.g., as identified generally by reference numeral 60). As examples, the machine-learned model(s) 60 can be or can otherwise include various machine-learned models such as, for example, neural networks (e.g., deep neural networks, etc.), support vector machines, decision trees, ensemble models, k-nearest neighbors models, Bayesian networks, logistics models, gradiant boost models, XGBoost models, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks. The machine-learned models of the cloud server 52 may be used to analyze the appliance data transmitted from the oven appliance 100. Additionally or alternatively, cloud server 52 can train the machine-learned models through use of a model trainer (e.g., training algorithm), as would be understood. For example, as explained above, these models may include supervised models (e.g., trained or targeted toward certain problems or occurrences) and/or unsupervised models and methods (e.g., used to detect clusters of data similarities). Optionally, such a model trainer may train machine-learned models based on a set of training data compiled from a plurality of different appliances, appliance models, etc.

Cloud server 52 may include a network interface to facilitate communication over one or more networks (e.g., network 174) with one or more network nodes. Network interface can be an onboard component or it can be a separate, off board component. In turn, cloud server 52 can exchange data with one or more nodes over the network 174. Furthermore, it is understood that cloud server 52 may further exchange data with any number of client devices over a network such as network 174. The client devices (e.g., such as remote device 172) can be any suitable type of computing device, such as a general purpose computer, special purpose computer, laptop, desktop, integrated circuit, mobile device, smartphone, tablet, or another suitable computing device. Information, signals, or other data (e.g., relating to appliance performance, fault conditions, analyzation results, inputs/outputs of machine-learned models, etc.) may thus be exchanged between oven appliance 100 and various separate client devices (e.g., directly to the user or maintenance technicians) through cloud server 52.

Referring again generally to FIGS. 1 through 3, in general, user interface panel 160 may enable user inputs 162 to allow the user to activate each heating element 150 and determine the amount of heat input provided by each heating element 150 to a cooking food items within cooking chamber 120. Although shown with user inputs 162, it should be understood that user inputs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include the controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user inputs 162. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

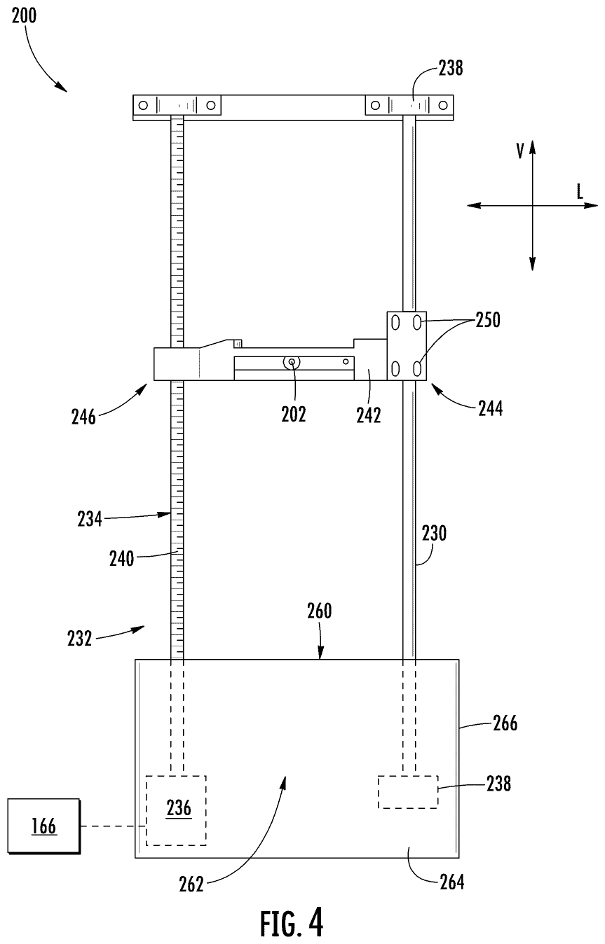

Referring now to FIGS. 2 through 5, cabinet door 124 and a camera assembly 200 will be described in more detail according to exemplary embodiments of the present subject matter. More specifically, according to exemplary embodiments, oven appliance 100 may include a camera assembly 200 which is positioned within cabinet door 124 and is generally configured for providing images of food items that are cooking within cooking chamber 120. In this regard, for example, camera assembly 200 includes a camera 202 that is configured for taking still images or video and transmitting those images to a user to provide feedback regarding the cooking process. For example, camera 202 can provide a live image or video to display 164 (FIG. 1) upon user request. According to still other embodiments, camera 202 may be a thermal imaging device or any other device for providing the user with feedback regarding the food items being cooked within cooking chamber 120. In an alternative embodiment, camera 202 may obtain an image of a food item, container, or vessel inside cabinet 102 and communicate that data to controller 166 to adjust the location of the adjustable rack assembly 300 within the cabinet 102 of the oven appliance 100.

Notably, installing a camera in a cooking appliance where it may be exposed to high temperatures can result in operability issues, poor image quality, and component failure. For example, conventional cameras are positioned outside of the cooking chamber to ensure a safe operating temperature. Alternatively, conventional cameras require complex and costly cooling system to maintain a safe operating temperature for the camera and its temperature sensitive electronic components. Therefore, aspects of the present subject matter are directed to features of cabinet door 124 and camera assembly 200 which permit safe operation of camera 202 while ensuring high quality images. As best shown in FIG. 3, a cabinet door 124 generally includes an inner door panel positioned proximate cooking chamber 120 and an outer door panel (i.e. separation panel) positioned proximate an ambient environment (e.g., outside of oven appliance 100). In general, each of inner door panel and outer door panel may include one or more transparent windows (such as window 128). Although these windows are referred to herein as glass panes, it should be appreciated that these transparent windows may be constructed of any suitably rigid and temperature resistant material, e.g., such as acrylic glass or Plexiglass. However, according to alternative embodiments, inner door panel and/or outer door panel may be solid or constructed from any other suitable material.

As shown in FIGS. 2 through 5, camera assembly 200 generally includes one or more guide rails 230 that are generally configured for facilitating movement of camera 202 and proper alignment of camera 202 relative to cooking chamber 120 and food items located therein. According to the illustrated embodiments, guide rails 230 are circular steel rods that extend substantially along the vertical direction V between a bottom 106 and a top 104 of cabinet 102. It should be appreciated that as used herein, terms of approximation, such as “approximately,” “substantially,” or “about,” refer to being within a ten percent margin of error.

Although camera assembly 200 is described herein is being configured for moving camera 202 along the vertical direction V, it should be appreciated that according to alternative embodiments, aspects of the present subject matter may facilitate movement along the horizontal direction or any other suitable angle and/or direction. In addition, according to the illustrated embodiment, camera assembly 200 is positioned within the cabinet door 124, e.g., between inner door panel and outer door panel. However, it should be appreciated that according to alternative embodiments, camera assembly 200 may be positioned elsewhere within cabinet 102, such as along a sidewall 130 of cooking chamber 120.

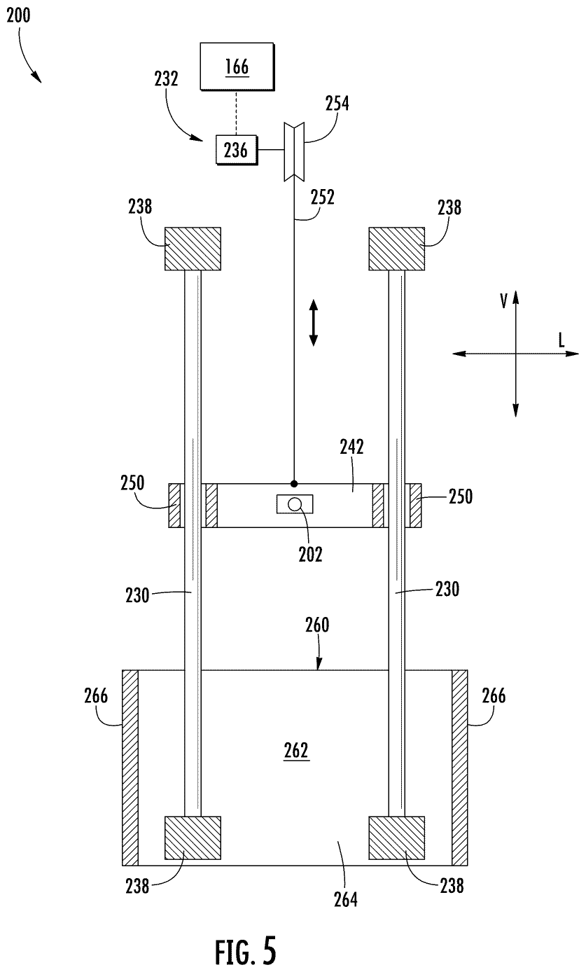

According to exemplary embodiments, camera assembly 200 may include any suitable number of guide rails 230 positioned in any suitable manner and having any suitable size or geometry. For example, the embodiment illustrated in FIGS. 2 through 4 includes a single guide rail 230, while the embodiment illustrated in FIG. 5 includes two guide rails 230 spaced apart along a lateral direction L. Although guide rails 230 are illustrated herein is being circular metal rods, it should be appreciated that according to alternative embodiments, guide rails 230 may be square, rectangular, or any other suitable shape. In addition, guide rails 230 may include any other suitable features for facilitating smooth movement of camera 202, such as a geared track for facilitating a geared timing arrangement with camera 202.

Referring now specifically to the embodiment illustrated in FIGS. 2 through 4, camera 202 may be movably mounted to guide rail 230 and camera assembly 200 may further include a drive mechanism 232 that is mechanically coupled to camera 202 for moving camera 202 along guide rail 230. More specifically, drive mechanism 232 may include a lead screw 234 that is mechanically coupled to camera 202 and a drive motor 236 that is mechanically coupled to lead screw 234 for rotating lead screw 234 to move camera 202 along guide rail 230. According to the illustrated embodiment, lead screw 234 extends parallel to guide rail 230 to facilitate vertical movement of camera 202 without binding. As shown, guide rails 230 and/or lead screw 234 may be mounted and supported by one or more pillow block bearings, bushings, or other suitable mounting structures 238, e.g., at a top and bottom of their respective lengths.

As shown, lead screw 234 may be an elongated threaded shaft with screw threads 240 that are configured for engaging complementary threads (not shown) defined within a camera housing 242. In this regard, according to the illustrated embodiment, camera 202 may be mounted to guide rails 230 and lead screw 234 using camera housing 242, which may be formed using any suitable material and which extends along the lateral direction L for mechanically engaging lead screw 234 and slidably mounting to guide rail 230. Specifically, camera housing 242 defines a first end 244 and a second end 246 spaced apart along the lateral direction L. Guide rail 230 slidably couples to first end 244 and lead screw 234 mechanically engages second end 246.

Camera housing 242 may generally define any suitable features or geometries for receiving camera 202 and for engaging guide rails 230 and/or lead screw 234. In this regard, for example, camera assembly may define one or more bushings 250 for providing a low friction interface between camera housing 242 and guide rail 230. Specifically, according to the illustrated embodiment, camera housing defines two bushings 250 spaced vertically within first end 244 of camera housing 242 for facilitating proper alignment and smooth sliding of camera housing 242. In addition, as mentioned above, second end 246 of camera housing 242 may define complementary threads for engaging screw threads 240 of lead screw 234.

As used herein, “motor” may refer to any suitable drive motor and/or transmission assembly for rotating lead screw 234 or otherwise moving camera 202 along guide rail 230. For example, drive motor 236 may be a brushless DC electric motor, a stepper motor, or any other suitable type or configuration of motor. For example, drive motor 236 may be an AC motor, an induction motor, a permanent magnet synchronous motor, or any other suitable type of AC motor. In addition, drive motor 236 may include any suitable transmission assemblies, clutch mechanisms, or other components. According to exemplary embodiments, controller 166 may be in operative communication with drive motor 236 for regulating operation of drive motor 236 and movement of camera 202.

The embodiment of camera assembly 200 illustrated in FIGS. 2 through 4 includes a drive mechanism 232 having a lead screw 234 that rotates to move camera 202 up or down along the vertical direction V. However, it should be appreciated that according to alternative embodiments, any other suitable drive mechanism may be used while remaining within the scope of the present subject matter. For example, referring briefly to FIG. 5, another exemplary embodiment of camera assembly 200 will be described. Due to the similarity between the embodiments described herein, like reference numerals may be used to refer to the same or similar features.

As shown in FIG. 5, camera housing 242 is mounted on two parallel guide rails 230 that are positioned within the air gap of cabinet door 124. Camera housing 242, and thus camera 202, may slide freely along the vertical direction V. According to this exemplary embodiment, drive mechanism 232 includes a guide wire 252 that is mechanically coupled or attached to camera 202 or camera housing 242. In addition, drive motor 236 may be configured for rotating a pulley 254 that winds and unwinds guide wire 252 to lift or lower camera housing 242. Thus, according to this exemplary embodiment, drive motor 236 and pulley 254 are mounted at a top of cabinet door 124. It should be further appreciated that other drive mechanisms are possible and within the scope of the present subject matter, such as belt driven systems, chain driven systems, bolt driven systems, etc.

Therefore, according to exemplary aspects of the present subject matter, controller 166 may be configured for operating drive motor 236 to selectively position camera housing 242 and camera 202 at any suitable vertical location within cabinet door 124 for taking photos or video of a particular rack location of adjustable rack assembly 300 or food item positioned on the adjustable rack assembly 300 within cooking chamber 120. In addition, according to exemplary embodiments, camera assembly 200 or camera housing 242 may further include features for moving camera 202 along a lateral direction L, for angling camera 202 relative to a horizontal plane or the transverse direction T, or for regulating the position or operation of camera 202 any other suitable manner.

Referring still to FIGS. 2 through 5, camera assembly 200 may further include a heat shield 260 that extends around the one or more guide rails 230 and defines a protective cavity 262 that is configured for receiving camera 202 and providing a thermal break from the heat and/or heating elements 150 within cooking chamber 120. In this regard, according to the illustrated embodiment, heat shield 260 is formed from metal and may include one or more insulating structures, materials, or other layers to limit the exposure of sensitive electronic components of camera 202 from the high heat and thermal energy within cooking chamber 120.

According to the illustrated embodiment, heat shield 260 is positioned proximate a bottom of cabinet door 124 within air gap. As shown, camera housing 242 may slide entirely within protective cavity 262. Specifically, as illustrated, heat shield 260 may be U-shaped and may include a front plate 264 positioned proximate inner door panel and two side plates 266 that extend from the front plate 264 and inner door panel toward outer panel for substantially enclosing protective cavity 262. It should be appreciated that according to alternative embodiments, heat shield 260 may be constructed from any other suitable material and may have any other suitable size, geometry, and cooling features.

According to exemplary embodiments, controller 166 may be programmed for protecting camera 202 during high temperature operation of oven appliance 100. Specifically, for example, high-temperature operation may refer to broil cycles, cooking cycles that operate above is particular temperature threshold, such as 500° F. or 600° F., or a self-cleaning cycle when cooking chamber 120 may reach temperatures of 800° F. or greater. Thus, when a user initiates such a high temperature operating cycle using user interface panel 160, controller 166 may move camera 202 into protective cavity 262 to prevent damage. Alternatively, controller 166 may monitor the chamber temperature, e.g., using temperature sensor 168, and may move camera 202 into protective cavity 262 when the chamber temperature exceeds a predetermined temperature threshold, such as about 400° F., about 500° F., about 600° F., about 700° F., about 800° F., or greater.

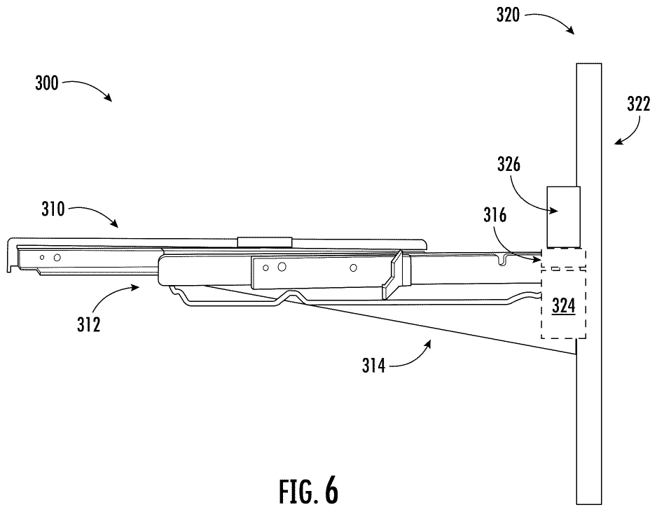

Referring now to FIGS. 2, 3, and 6, an exemplary adjustable rack assembly 300 is provided. The adjustable rack assembly 300 includes a rack frame 310 defining a permeable support surface extending along a transverse direction between a front end 112 and a rear end 114. The adjustable rack assembly 300 enables a user to provide a targeted rack position defining a positioning preference for placing a food item or vessel onto the adjustable rack assembly 300 and/or removing the food item or vessel from the adjustable rack assembly 300. This targeted rack position may include a vertical and/or horizontal position preference. The targeted rack position may be provided to the oven appliance 100 or the adjustable rack assembly 300 therein by having a user input their preference via user inputs 162 on the oven appliance 100. In an alternative embodiment, the user may provide the target rack position via remote device 172 in communication with cloud system 50 as well as controller 166.

The rack frame 310 may be mechanically coupled to a vertical positioning assembly 320 within the cabinet 102. The vertical positioning assembly 320 provides support for the rack frame 310. The vertical positioning assembly 320 may include a vertical motor 324, a drive mechanism 322, and a vertical motor actuator 326. In one example embodiment, the vertical positioning assembly 320 may be a rack and pinion engaged by a gear on a motor, belt drive, hydraulic actuator, or any other appropriate means. As used herein, “motor” may refer to any suitable drive motor and/or transmission assembly for adjusting the rack frame 310 or otherwise moving vertical positioning assembly 320 along drive mechanism 322. For example, vertical motor 324 may be a brushless DC electric motor, a stepper motor, or any other suitable type or configuration of motor. For example, vertical motor 324 may be an AC motor, an induction motor, a permanent magnet synchronous motor, or any other suitable type of AC motor. In addition, vertical motor 324 may include any suitable transmission assemblies, clutch mechanisms, or other components. According to exemplary embodiments, controller 166 may be in operative communication with vertical motor 324 for regulating operation of vertical motor 324 and movement of vertical positioning assembly 320.

The controller 166 may be in operative communication with the vertical positioning assembly 320 and the camera assembly 200. The controller 166 may be configured to obtain an image of the cooking chamber 120 using camera assembly 200, and operate the vertical positioning assembly 320 to position rack frame 310 based at least in part on the image of the cooking chamber 120. Upon receiving instructions from the controller 166, the vertical motor actuator 326 and vertical motor 324 may move the rack frame 310 along the vertical direction via the drive mechanism 322 within the cabinet 102 of oven appliance 100. Although not pictured, the vertical positioning assembly 320 and specifically the vertical motor 324, drive mechanism 322, and/or vertical motor actuator 326 may be equipped with heat protecting elements similar elements to the camera assembly 200 as discussed in detail above (e.g. using a heat shield 260 along with a protective cavity 262 equipped with front plate 264 and side plates 266 to protect the vertical positioning assembly when the oven appliance 100 is operating in high-temperature operation).

Additionally or alternatively, the adjustable rack assembly 300 may include a horizontal extender rack 312. The horizontal extender rack 312 is able to extend outside the cabinet 102 along the transverse direction to allow for loading/unloading of a food item or vessel. The horizontal extender rack 312 may be mechanically coupled to a horizontal actuator 316 configured to extend and retract the horizontal extender rack 312. The horizontal actuator 316 may be communicatively coupled to controller 166. Similar to the target rack position, the user may provide their preference for the position of the horizontal extender rack 312 via user inputs 162 on the oven appliance 100 or via remote device 172 in communication with cloud system 50 as well as controller 166. Therefore, the controller 166 may provide instructions to horizontal actuator 316 to extend the horizontal extender rack 312 when the cabinet door 124 is open. Additionally or alternatively, the controller 166 may provide instructions to horizontal actuator 316 to retract the horizontal extender rack 312 when the cabinet door 124 is closed. In one example embodiment, the horizontal actuator 316 is a pneumatic actuator. In an alterative embodiment, the horizontal actuator 316 is an electric actuator.

In another example embodiment, the adjustable rack assembly 300 may further include a rack support arm 314 positioned directly below the rack frame 310. The rack support arm 314 may be mechanically coupled to the rack frame 310 and the vertical positioning assembly 320. The positioning of the rack support arm 314 defines a rack height setting, which is the position of the rack frame along the vertical axis of the cabinet 102 of oven appliance 100. The rack height setting will include a maximum height setting that is below the top of the cabinet 102.

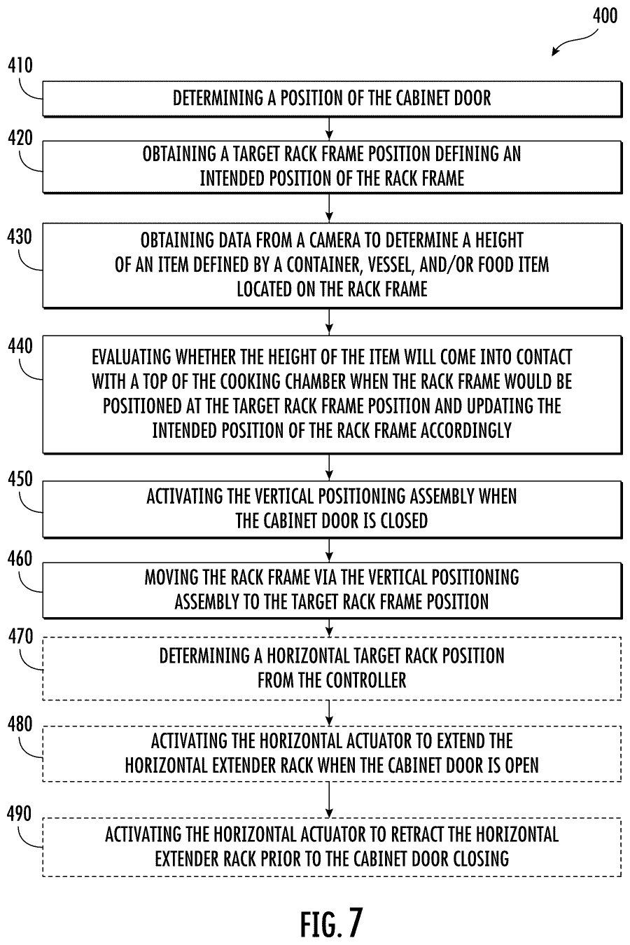

Referring to FIG. 7, method 400 includes, at 410, determining a position of the cabinet door. As explained above, using oven appliance 100 as an example, the cabinet door's position may be determined by a means of determining cabinet door 124 position, which may include a sensor, switch, motion detector, etc. This means of determining a cabinet door 124 position is communicatively coupled to controller 166.

Method 400 further includes, at 420, obtaining a target rack frame position defining an intended position of the rack frame. As explained above, and again using oven appliance 100 as an example, a controller 166 will be configured to receive a user preference for the targeted rack position defining a positioning preference for the rack frame 310 of the adjustable rack assembly 300. This preference may be communicated to the controller 166 via the remote device 172, user inputs 162, or any other client device.

Method 400 further includes, at 430, obtaining data from a camera to determine a height of an item defined by a container, vessel, and/or food item located on the rack frame. As explained above, and again using oven appliance 100 as an example, the camera 202 will obtain an image of the cooking chamber 120 and provide that image to controller 166.

Method 400 further includes, at 440, evaluating whether the height of the item will come into contact with a top of the cooking chamber when the rack frame would be positioned at the target rack frame position and updating the intended position of the rack frame accordingly. As explained above, and again using oven appliance 100 as an example, controller 166 may receive images from camera 202 of the cooking chamber 120. Then, the controller 166, which may be in communication with cloud server 52, will use the image data to determine whether the target rack position will result in the item on the rack frame 310 touching the top of the cooking chamber 120. In one embodiment, the determination may include a baseline amount of space between the top of the cooking chamber 120 and the top of the item. The image data may be deciphered in a topographic manner to determine the size and positioning of the item within the cooking chamber 120 to assist in determining whether item will come into contact with the top of the cooking chamber 120.

Method 400 further includes, at 450, activating the vertical positioning assembly when the cabinet door is closed. As explained above, and again using oven appliance 100 as an example, controller 166 may receive the position of the cabinet door via means of determining cabinet door 124 position, which may include a sensor, switch, motion detector, etc. Once the cabinet door 124 is closed, controller 166 will provide instructions to the vertical positioning assembly 320, which may involve activating vertical motor actuator 326 and vertical motor 324.

Method 400 further includes, at 460, moving the rack frame via the vertical positioning assembly to the target rack frame position. As explained above, and again using oven appliance 100 as an example, vertical positioning assembly 320 activates to adjust vertical position of rack frame 310, which may involve the use of drive mechanism 322.

Method 400 may further include, at 470, determining a horizontal target rack position from the controller. As explained above, and again using oven appliance 100 as an example, controller 166 will be configured to receive a user preference for the targeted rack position defining a positioning preference for the rack frame 310 of the adjustable rack assembly 300. This preference may be communicated to the controller 166 via the remote device 172, user inputs 162, or any other client device.

Method 400 may further include, at 480, activating the horizontal actuator to extend the horizontal extender rack when the cabinet door is open. As explained above, and again using oven appliance 100 as an example, controller 166 may receive the position of the cabinet door via means of determining cabinet door 124 position, which may include a sensor, switch, motion detector, etc. Once the cabinet door 124 is open, controller 166 will provide instructions to the horizontal actuator 316, which may involve extending the horizontal extender rack 312.

Method 400 may further include, at 490, activating the horizontal actuator to retract the horizontal extender rack prior to the cabinet door closing. As explained above, and again using oven appliance 100 as an example, controller 166 may receive the position of the cabinet door via means of determining cabinet door 124 position, which may include a sensor, switch, motion detector, etc. Once the cabinet door 124 is closed, controller 166 will provide instructions to the horizontal actuator 316, which may involve retracting the horizontal extender rack 312.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a mutually orthogonal vertical direction, lateral direction, and transverse direction, the oven appliance comprising:
a cabinet defining a cooking chamber;
a cabinet door; and
an adjustable rack assembly, the adjustable rack assembly comprising:
a rack frame extending along a transverse direction between a front end and a rear end;
a vertical positioning assembly supporting the rack frame within the cabinet;
a camera assembly for obtaining images of the cooking chamber; and
a controller in operative communication with the vertical positioning assembly and the camera assembly, the controller being configured to:
obtain an image of the cooking chamber using the camera assembly; and
operate the vertical positioning assembly to position the rack frame based at least in part on the image of the cooking chamber.

2. The oven appliance of claim 1, wherein the rack frame defines a permeable support surface and further comprises:
a horizontal extender rack; and
a horizontal actuator configured to extend and retract the horizontal extender rack.

3. The oven appliance of claim 2, wherein the horizontal actuator is configured to extend the horizontal extender rack when the cabinet door is open.

4. The oven appliance of claim 1, wherein the vertical positioning assembly comprises:
a vertical motor;
a drive mechanism; and
a vertical motor actuator.

5. The oven appliance of claim 1, the adjustable rack assembly further comprising:
a rack support arm positioned under the rack frame and coupled to the vertical positioning assembly defining a rack height setting, wherein the rack height setting comprises a maximum height setting that is below a top of the cabinet.

6. The oven appliance of claim 1, wherein the camera assembly comprises:
a housing defining a first end positioned at a first opening of a cabinet wall and a second end positioned at a second opening defined in a separation panel;
a first viewing window mounted within the first end of the housing;
a second viewing window mounted within the second end of the housing; and
a camera positioned outside the housing and adjacent the second viewing window.

7. An adjustable rack assembly for an oven appliance, the adjustable rack assembly comprising:
a rack frame extending along a transverse direction between a front end and a rear end;
a vertical positioning assembly supporting the rack frame within a cabinet defining a cooking chamber;
a camera assembly for obtaining images of the cooking chamber; and
a controller in operative communication with the vertical positioning assembly and the camera assembly, the controller being configured to:
obtain an image of the cooking chamber using the camera assembly; and
operate the vertical positioning assembly to position the rack frame based at least in part on the image of the cooking chamber.

8. The adjustable rack assembly of claim 7, wherein the rack frame defines a permeable support surface and further comprises:
a horizontal extender rack; and
a horizontal actuator configured to extend and retract the horizontal extender rack.

9. The adjustable rack assembly of claim 8, wherein the horizontal actuator is configured to extend the horizontal extender rack when a cabinet door is open.

10. The adjustable rack assembly of claim 7, wherein the vertical positioning assembly comprises:
a vertical motor;
a drive mechanism; and
a vertical motor actuator.

11. The adjustable rack assembly of claim 7, the adjustable rack assembly further comprising:
a rack support arm positioned under the rack frame and coupled to the vertical positioning assembly defining a rack height setting, wherein the rack height setting comprises a maximum height setting that is below a top of a cabinet defining the cooking chamber.

12. The adjustable rack assembly of claim 7, wherein the camera assembly comprises:
a housing defining a first end positioned at a first opening of a cabinet wall and a second end positioned at a second opening defined in a separation panel;
a first viewing window mounted within the first end of the housing;
a second viewing window mounted within the second end of the housing; and
a camera positioned outside the housing and adjacent the second viewing window.

13. A method for operating an oven appliance, the oven appliance comprising a cabinet defining a cooking chamber; a cabinet door; and an adjustable rack assembly, the adjustable rack assembly comprising a rack frame extending along a transverse direction between a front end and a rear end, a vertical positioning assembly supporting the rack frame within the cabinet, and a controller in operative communication with the vertical positioning assembly and a camera assembly, the controller being configured to obtain an image of the cooking chamber using the camera assembly, and operate the vertical positioning assembly to position the rack frame based at least in part on the image of the cooking chamber; the method comprising:
determining a position of the cabinet door;
obtaining a target rack frame position defining an intended position of the rack frame;
obtaining data from a camera to determine a height of an item defined by a container, vessel, and/or food item located on the rack frame;
evaluating whether the height of the item will come into contact with a top of the cooking chamber when the rack frame would be positioned at the target rack frame position and updating the intended position of the rack frame accordingly;
activating the vertical positioning assembly when the cabinet door is closed; and
moving the rack frame via the vertical positioning assembly to the target rack frame position.

14. The method of claim 13, the rack frame further comprising:
a horizontal extender rack; and
a horizontal actuator configured to extend and retract the horizontal extender rack.

15. The method of claim 14, wherein the horizontal actuator is a pneumatic actuator.

16. The method of claim 14, the method further comprising:
determining a horizontal target rack position from the controller; and
activating the horizontal actuator to extend the horizontal extender rack when the cabinet door is open.

17. The method of claim 16, the method further comprising:
activating the horizontal actuator to retract the horizontal extender rack when the cabinet door is closed.

18. The method of claim 13, wherein the vertical positioning assembly comprises:
a vertical motor;
a drive mechanism; and
a vertical motor actuator.

19. The method of claim 13, wherein the target rack frame position is defined by a user input communicated to the controller.

20. The method of claim 13, wherein the target rack frame position is defined by a default positioned set by a manufacturer communicated to the controller.
